(19) United States
(12) Patent Application Publication
(10) Pub. No.: US 2024/0123419 A1
(43) Pub. Date: Apr. 18, 2024

(54) Tubular Reaction Unit

(71) Applicant: SYNHELIX, Evry-Courcouronnes (FR)

(72) Inventors: Alexis JOBARD, Evry-Courcouronnes (FR); Renaud RAHIER, Evry-Courcouronnes (FR); Irina RANDRIANJATOVO-GBALOU, Evry-Courcouronnes (FR); Ahmed SAID, Evry-Courcouronnes (FR)

(21) Appl. No.: 18/286,785

(22) PCT Filed: Apr. 14, 2022
(86) PCT No.: PCT/EP2022/060140

§ 371 Date: Oct. 13, 2023

(30) Foreign Application Priority Data
Apr. 14, 2021 (EP) 21305487.7

(51) Int. Cl. B01J 19/00; B01L 7/00

(52) U.S. Cl. CPC B01J 19/0046; B01L 7/52; B01J 2219/00495; B01J 2219/00511; B01J 2219/00716; B01J 2220/40; B01J 2220/62

(57) ABSTRACT

The present invention relates to a reaction unit (10) configured to receive a reaction solution or culture media and configured to be placed inside a thermocycler, said reaction unit (10) comprising an elongated hollow body (12) extending along a flowing axis X, the hollow body (12) thus displaying a first opening (14) at its first extremity (16) and a second opening (18) at its second extremity (20). The walls of the hollow body (12) are at least partially made of a thermally conductive material. The reaction unit (10) further comprises at least one filter element (22) extending inside the hollow body (12), the filter element (22) being sealingly secured to the walls of the hollow body (12) over its complete circumference, leading any fluid flowing from the first opening (14) to the second opening (18) to cross the at least one filter element (22).

### FIELD OF INVENTION

The present invention relates to a tubular filtration kit.

### BACKGROUND OF INVENTION

The synthesis of (macro) molecules and polymers, whether carried out chemically, biologically or biochemically, is a fundamental issue in modern industries, such as the pharmaceutical, food and petrochemical industries.

More particularly, the production and synthesis of de novo nucleic acids, single or double stranded, or specific cell cultures is today a major pharmaceutical issue since the development of bio-therapeutic technologies such as DNA/RNA vaccines, gene therapy or even cell therapy is taking an unprecedented boom. However, to be industrialized, these technologies require a large amount of genetic material with a high degree of purity, essential criteria to meet GMP standards.

Nowadays, the synthesis of nucleic acids is classically carried out in a chemical way by means of technologies based on the phosphoramidite approach. However, these technologies have the drawback of limiting, either the size of the strand synthesized or the final synthesis yield. Thus for the production of a strand of 120 nucleotides, the final yield is regularly less than 50%, without even considering the losses occurred during the purification steps and different necessary treatments to render the final product compatible for a pharmacological application.

The synthesis of oligonucleotides by the enzymatic method is therefore becoming an approach of interest. Indeed, certain enzymes naturally have the capacity to lengthen, repair and control nucleic acid sequences, in aqueous solutions that are not very harmful and with higher yields than chemistry.

However, regardless of the desired (macro) molecule, polymers (biological polymers or chemical polymers), oligonucleotides or other kind of (macro) molecules, it is well known in the state of the art that obtaining those (macro) molecules usually requires several successive or cyclic synthesis steps which generally further require intermediate purification steps. Thus, beyond the development of the synthesis methods themselves, a major obstacle for the industries to succeed in large-scale synthesis of (macro) molecules and polymers is the lack of said industries to be able to purify the reactions products between each synthesis step, meaning being able to separate the reaction products from unincorporated reagents, synthesis catalysts as well as reaction by-products.

In order to achieve those purification steps, several methods can be used, such as chromatography or electrophoresis (Syrdn et al. 2007). However, although these methods are very efficient and generally lead to extremely pure reaction products, the complexity, the implementation time as well as the sometimes very high cost of those methods, render them difficult to use at an industrial scale.

Also, laboratory automation has played a key role in the advancement of genomics, synthetic biology and drug discovery over the past decade. Different level of automation of the various steps varies, ranging from manually step for the feeding of raw materials to fully integrated processes. According to the final purpose, each configuration has demonstrated some advantage, however with a manual setup, there are significant issues with human error resulting in misinterpretation of results but also it makes the whole process labor intensive; not to mention the risks of contamination when transferring from one system to another. Other laboratories utilize pipetting robots to accomplish these preparative steps (such as plate-to-plate liquid transfers, plate sealing, plate-thermocycling with magnetic beads) but these systems are complicated and expensive to build and may suffer from sample evaporation problems and volume constraints.

More particularly, for the classical addition of a nucleotide or ribonucleotide inside reaction wells, it is necessary to carry out four separations between the product of interest and the reagents. Separations need to be repeated for the number of bases to add in order to achieve the desired strand length.

In those specific cases the volumes to be evacuated after each filtering step are low for each filtration (50-500 μL) however they are to be repeated by the number of reagents necessary for the addition of a base (4), the number of additions (100) and the different syntheses that can be carried out in parallel (1 to 48). It is then quickly observed that the volumes to be eliminated are several liters.

To respond to these problems, existing products offer a system with a 96-well plate, the filters of which are already integrated in the wells. However, these systems are only suitable for a few filtration cycles and include a waste management system that is unsuitable in terms of volume. Not to mention their incompatibility to integrate a thermoregulation system.

The current invention aims at solving the here-above mentioned issues in enabling the use of a single functional reaction unit enabling to easily carry out each filtering step without having to dismantle the reaction device at each step.

The current invention further aims at providing a handy, small, easy to handle and partly reaction unit to do so.

### SUMMARY

This invention thus relates to a reaction unit configured to receive a reaction solution and configured to be placed inside a thermocycler, said reaction unit comprising an elongated hollow body extending along a flowing axis X, the hollow body thus displaying a first opening at its first extremity and a second opening at its second extremity, wherein the walls of the hollow body are at least partially made of a thermally conductive material, wherein the reaction unit further comprises at least one filter element extending inside the hollow body, the filter element being secured in a sealed to the walls of the hollow body over its complete circumference, leading any fluid flowing from the first opening to the second opening to cross the at least one filter element.

This way, this solution enables to integrate the filtration in individual reaction elements improving efficiency and safety and further enabling an easy automatization of the process. The reaction conditions are improved as thermoregulation is easily transferred inside each reaction unit.

The device according to the invention may comprises one or several of the following features, taken separately from each other or combined with each other:
the diameter of the first opening is larger than the diameter of the second opening,
the hollow body displays a general frustoconical shape, the at least one filter element being situated in the frustoconical second extremity of the hollow body,
the at least one filter element is made of a hard material,
the at least one filter element comprises a filter membrane made of a flexible material,
the hollow body comprises two parts configured to be removably assembled with each other, the first part comprising the first opening, the second part comprising the second opening and further comprising the at least one filter element,
the second part is the frustoconical second extremity of the hollow body,
the thermally conductive material comprises aluminum,
the reaction unit further comprises a sealing cap configured to seal the first opening,
the sealing cap is configured to seal the first opening in a removable way,
the first extremity of the reaction unit comprises mechanical clinging means configured to connect the reaction unit to a carrying device,
the second extremity of the reaction unit displays external connection means configured to cooperate with the thermocycler,
the reaction unit comprises at least two reaction compartments connected along the flowing axis X, each reaction compartment comprising a filter element, all the filter elements being, when all the reaction compartments are assembled, aligned along the flowing axis X,
filter element displays filtering properties different from the filtering properties of the other filter elements,
the reaction unit is a passive element which is not affected by the reaction carried inside the hollow body.

### BRIEF DESCRIPTION OF THE DRAWINGS

The invention will be better understood, and other aims, details, characteristics and advantages thereof will emerge more clearly on reading the detailed description which follows, of one or several embodiments of the invention given by way of illustration. Those are purely illustrative and non-limiting examples, with reference to the accompanying schematic drawings.

On these drawings:

FIG. 1 is a perspective view of a first embodiment according to the invention,

FIG. 2 is a perspective view of a second embodiment according to the invention,

FIG. 3 is a perspective view of a third embodiment according to the invention,

FIG. 4 is a perspective view of a fourth embodiment according to the invention,

FIG. 5 is a perspective view of a fifth embodiment according to the invention,

FIG. 6 is a perspective view of a sixth embodiment according to the invention.

### DETAILED DESCRIPTION

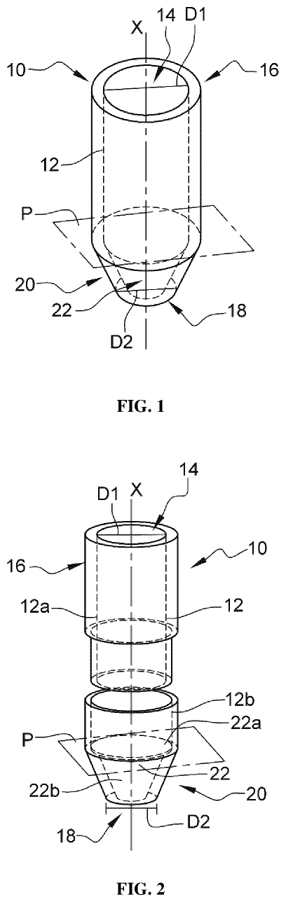

As can be seen on FIG. 1, a reaction unit 10 according to the present invention comprises an elongated hollow body 12 extending along a flowing axis X. The hollow body 12 displays a first opening 14 at its first extremity 16 and a second opening 18 at its second extremity 20.

As can be seen on the figures, the diameter D₁ of the first opening 14 is larger than the diameter D₂ of the second opening 18. More precisely, the diameter D₁ is about 7 mm and the diameter D₂ is about 3 mm. More particularly, in the represented embodiments, the hollow body 12 displays a general frustoconical shape. In some non-represented embodiments, the hollow body 12 might display a general conical form. The hollow body 12 has a total height of about 20 mm, the straight part of it measuring at least 15 mm and the conical part measuring about 5 mm. A conical or frustoconical shape allows easier and more regular pipetting despite the volume reduction.

The reaction unit 10 according to the present invention is thus configured to receive a reaction solution, as for example a synthesis reaction mix comprising the enzyme and its co-factors. A reaction solution can also be a cell culture medium. The reaction solution can therefore flow through the hollow body 12, along the flowing axis X, from the first opening 14 to the second opening 18. The first extremity 16 is thus the upstream extremity, the first opening 14 is thus the upstream opening, the second opening 18 is thus the downstream opening and the second extremity 20 is thus the downflow extremity, according to flowing axis X. The reaction solution is poured into the reaction unit 10 through the first opening 14.

The walls of the hollow body 12 are at least partially made of a thermally conductive material, in order to convey heat, for example heat emitted by a thermocycler. The hollow body might be made of a matrix of composite material in comprising some elements of a thermally conductive material. It might also be completely made of thermally conductive material depending on the embodiments. The thermally conductive material might be aluminum or copper. A highly thermally conductive material is preferred as quick temperatures changes improve the efficiency of some reaction steps. Many reaction protocols are very strict regarding temperature changes and a good temperature reactivity can lead to a significant efficiency change. The reaction unit 10 according to the present invention is thus particularly suited for being placed inside a thermocycler. In the represented embodiments, the walls of the hollow body 12 comprise aluminum. In some embodiments, the walls of the hollow body 12 are entirely made of aluminum. Aluminum is very light and displays strong thermally conductive properties. In an alternative embodiment, the walls of the hollow body 12 are made of plastic with a low-binding surface, or a Teflon®/low-bind type surface treatment.

The walls of the hollow body 12 are about 1 mm thick. In some embodiments, the thickness might vary along the length of the hollow body.

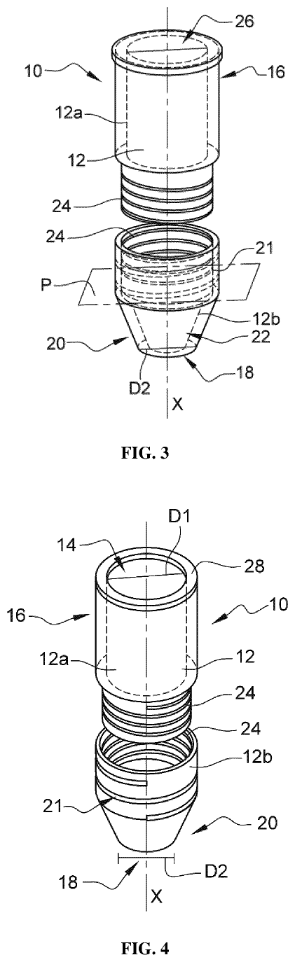

Regarding that the reaction unit 10 according to the present invention aims at being used inside a thermocycler, the second extremity 20 of the hollow body 20 may display external connection means 21 configured to cooperate with the thermocycler, for example an external thread, as can be seen on FIGS. 3, 4 and 5. The external connection means 21 may alternatively comprise a bayonet fitting (not represented). This enables a safe and removable securing of the reaction unit 10 inside the thermocycler, to guarantee a strong sealing and avoid any possible accident in case of strong agitation, for example. In another not represented embodiment, those external connection means 21 may also comprise magnetic means.

As can be seen on FIGS. 1 and 2, the reaction unit 10 comprises a filter element 22 extending inside the hollow body 12. In the represented embodiments, the section of the filter element 22 extends in a plan P sensibly perpendicular to the flowing axis X. This plan P could also be inclined with regards to the flowing axis X. The filter element 22 is preferably located close or in contact with the edges of the second opening 18 of the hollow body 12. In case the hollow body displays a frustoconical shape, the filter element 22 is thus situated in the frustoconical tip of the hollow body 12.

The filter element 22 displays a shape or a section sensibly identical to the shape of the section of the hollow body 12. In the represented embodiments, the filter element 22 thus also displays a circular section or shape, fitting the circular section of the hollow body 12. The filter element 22 is thus sealingly secured (meaning: secured in a sealed way) to the walls of the hollow body 12 over its complete circumference, leading any fluid flowing from the first opening 14 to the second opening 18 to cross the filter element 22. The filter element 22 has a thickness comprised between 1 and 500 μm. The size of the pores ranges selectively between 1 and 5000 nm. Usually, one filter element 22 displays pores all sensibly of the same size. The filter element 22 is able to resist a temperature up to 400° C. and can be used in an environment having a pH comprised between 1 and 14.

In the embodiment illustrated on FIGS. 1 and 3, the filter element 22 is made of a hard material, as for example ceramics, or aluminum oxide. The filter element 22 in this embodiment may for example be a sintered body. In this embodiment, the filter element 22 displays a three-dimensional shape fitting the shape and the diameter of the section of the hollow body 12, preferably the shape and the diameter of the second extremity 18 of the hollow body 12. In the example illustrated on FIG. 1. The filter element 22 thus displays a conical shape and abuts against the edges of the second opening 18 of the hollow body 12.

In this embodiment, the filter element 22 is embedded within the hollow body 12, or even directly molded inside the hollow body 12, thus enabling the reaction unit 10 to withstand many repeated filtrations, over 5000, without deteriorating its physicochemical properties. Those many repeated filtrations enable a cyclic repetition of the reaction over and over again without any need of changing nor the filter element 22 nor the hollow body 12. As the reaction unit 10 is a passive element, in standard synthesis conditions, the carried-out reaction(s) do(es) not affect its shape or configuration or the composition of its wall or filer element 22, for example. New reactions can thus take place, in a repeated cyclic way, inside the reaction unit 10 without fear of any sort of interaction with the reaction unit 10 and therefore without any fear of unwanted reaction conditions evolution.

In this embodiment, the risk of cross contamination is at its lowest and the reaction unit is therefore safe to be used in a medical environment.

In this embodiment, the reaction solution flows through the filter element 22 along its whole height along the flowing axis X.

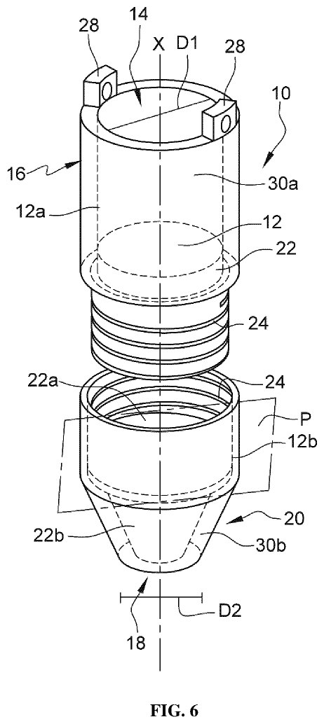

In the embodiment represented on FIGS. 2 and 6, the filter element 22a is made of a flexible material such as, for example, polyether sulfone or regenerated cellulose, or of a rigid material such as ceramics or aluminum oxide. In this case the filter element 22 comprises a filter membrane 22a which displays the general shape of a disc which thickness is up to 5 mm. In order to maintain the flexible filter membrane 22a in place, the filter elements 22 of the reaction unit 10 according to those embodiments, further comprise an abutment piece 22b made of hard material. Said abutment piece 22b comprises, for example ceramics, aluminum oxide, inox steel such as Sinterflo® MC Sintered Metal Mesh Composite, polyethylene or polypropylene such as Vyon® Sintered Porous Plastics. The abutment piece 22b is secured to the hollow body 12. The abutment piece 22b carries the flexible filter membrane 22a. In the represented embodiments on FIGS. 2 and 6, the abutment piece 22b displays a three-dimensional conical shape and abuts on the rims of the second opening 18. More generally, the abutment piece 22b displays a shape adapted to the hollow body, particularly to the second extremity 20 of the hollow body 12. The abutment piece 22b may be directly molded inside the hollow body. The abutment piece 22b displays physicochemical properties similar to the filter membrane 22a and comprises pores which size between 1 nm (1 kDa) and 300 μm.

In this embodiment, the reaction solution flows first through the filter membrane 22a and then through the abutment piece 22b along its whole height along the flowing axis X. It is therefore important that the abutment piece 22b displays the same or neutral physicochemical properties as the filter membrane 22a in order to not disturb the filtering process.

While the abutment piece 22b is embedded in a sealed way inside the hollow body, the filter membrane 22a, on the other hand, may, depending on the embodiment, be removably secured to the hollow body 12 and can thus be discarded and replaced by a new one after some time. This enables a larger choice of filter membranes 22a (ant thus of filter elements 22) for a same reaction unit 10, depending on the needed physicochemical properties. This can be particularly useful in a lab environment for teaching or research purposes, reducing thus the waste to the strict minimum and enabling to reuse the most of the reaction unit 10 for numerous reactions over time. Regarding those embodiments for use in research or teaching, it suffices to wash the reaction unit 10 with for example NaOH and then sterilize in order to be able to reuse (Sterlitech).

Classically, the reaction solution is poured inside the reaction unit 10 through the first opening 14 and the second opening 18 is connected to a vacuum device. The reaction solution remains in the reaction unit 10, upstream from the filter element 22 during the reaction time. The upstream part of the reaction unit 10, the part upstream the filter element 22 is therefore where the reaction takes place. It can be considered as a kind of reaction chamber. During the reaction time, the heat (or cold) emitted from the thermocycler is conducted to the reaction solution by means of the thermally conductive material of the walls of the hollow body 12. After the reaction time is over, the vacuum system is activated and the reaction solution is thus sucked through the filter element 22, from the upstream part of the reaction unit 10 (the reaction chamber) to the downstream part of the reaction unit 10. Depending on the reaction and on the filter element 22 physicochemical properties, the particles of interest either remain upstream the filter element while the remaining reaction solution is discarded or, on the opposite, the particles of interest go through the filter element 22 and the waste remains upstream the filter element 22. After the vacuum system has been activated, it can be deactivated, new reaction solution might be poured inside the reaction unit 10 upstream the filter element 22 and the reaction can be repeated. The vacuum system can then be activated again, etc. This can be repeated in a cyclic way over and over again without any need of changing neither the hollow body 12 nor the filter element 22 of the reaction unit 10. This way, the whole process including several reaction cycles can be repeated in a completely automatized way with no need to intervene around the reaction unit 10.

As the filtration enables the retention of particles of interest for a later step of the reaction, it is to be differentiated with a purification step, which ends the reaction. There can be several filtration steps during one reaction, for example with several filter elements 22 (see further below), or simply by refilling the upstream part of the reaction unit 10 several times after filtration steps. The particle of interest which are retained during a filtration step may vary from one reaction step to another, depending on the filled (or refilled) reaction solution.

In order to ease the recovering of the particle of interest in both here-above mentioned cases, in some embodiments, for example depicted on FIGS. 2, 3, 4, 5 and 6, the hollow body 12 of the reaction unit 10 comprises two parts 12a, 12b configured to be removably assembled with each other. In those embodiments, the first part 12a of the hollow body 12 comprises the first opening 14, and the second part 12b of the hollow body 12 comprises the second opening 18. In the represented embodiments, the second part 12b of the hollow body 12 further comprises the filter element 22. More precisely, in the represented embodiments, the second part 12b is the frustoconical second extremity 20 of the hollow body 12.

In those embodiments, the first part 12a (or upstream part) accommodates the reaction solution samples and its walls comprise thermally conductive material, while the second part 12b (or downstream part) incorporates the filter system and allows either easy waste disposal or easy particle recovery.

In the embodiment of FIG. 2, the first and second parts 12a, 12b cooperate by interlocking. In the embodiments of FIGS. 3, 4, 5 and 6, the first and second parts 12a, 12b each display internal connection means 24 in order to be removably secured to each other. In those embodiments, the internal connection means 24 are internal threads, and the two parts 12a, 12b cooperate by screwing. In another not represented embodiment, the internal connection means 24 may alternatively comprise a bayonet fitting or some magnetic elements.

Regarding the embodiments of FIGS. 3, 4 and 5 in which the second extremity 20 displays external connection means 21 being external threads, the internal threads are so called “left-handed” while the external threads are so called “right-handed” (or vice versa). The two screwing systems are thus inverse in order to avoid to unscrew the two parts 12a, 12b while trying to unscrew the reaction unit 10 from the thermocycler or vice versa.

As can be seen on FIGS. 2 and 6, in case the reaction unit 10 comprises a hollow body 12 in two parts 12a, 12b and a filter element 22 with a filter membrane 22a and an abutment piece 22b, the cooperation between the first and the second parts 12a, 12b enables to secure the filter membrane 22a in a sealed way. The edges of the filter membrane 22a are thus squeezed between the downflow rim of the first part 12a and the abutment piece 22b.

In the embodiment of FIG. 6, the reaction unit 10 comprises two filter elements 22. In some other embodiments, there might be more than two. Each part 12a, 12b comprise one filter element 22, each part 12a, 12b thus forming a distinct reaction compartment 30a, 30b. In some other embodiments, the reaction compartments 30a, 30b do not necessarily correspond to the parts 12a, 12b of the hollow body, as a single part 12a, 12b, might comprise several reaction compartments 30a, 30b. The reaction compartments 30a, 30b are, like the parts 12a, 12b, connected along the flowing axis X. They may be removably connectable but not necessarily. Each reaction compartment 30a, 30b comprises a filter element 22, and when all the reaction compartments 30a, 30b are assembled, all the filter elements 22 are aligned along the flowing axis X thus enabling to carry out two successive reactions within the same reaction unit 12. Such a system allows to compartmentalize two dependent reactions during which components of the first reaction might interfere with the second reaction. Such a system also enables the recovery of one reagent during the filtration process. For example, it is a strong advantage to recover the enzyme used during synthesis reaction while discarding waste reagents. This system can be realized by implementing two membranes with different pore sizes, the upper one having a pore size larger than the lower one.

Preferably, each filter element 22 displays filtering properties different from the filtering properties of the other filter elements 22, in order to create a succession of different reaction compartments 30a, 30b.

In the embodiment depicted on FIG. 3, the reaction unit 10 further comprises a sealing cap 26 configured to seal the first opening 14. Preferably, the sealing cap 26 is configured to seal the first opening 14 in a removable way. The presence of a sealing cap helps to avoid any cross contamination and offers the possibility to fill the void volume with inert gas such as argon or dinitrogen to avoid oxidation of reagents and products. In one embodiment, the sealing cap 26 is a rubber-like material plug, which would allow the pipetting and injection of the reaction solution via a syringe. In another embodiment, the first extremity 14 is shaped in a conical way to decrease solution splashing and avoid cross contamination.

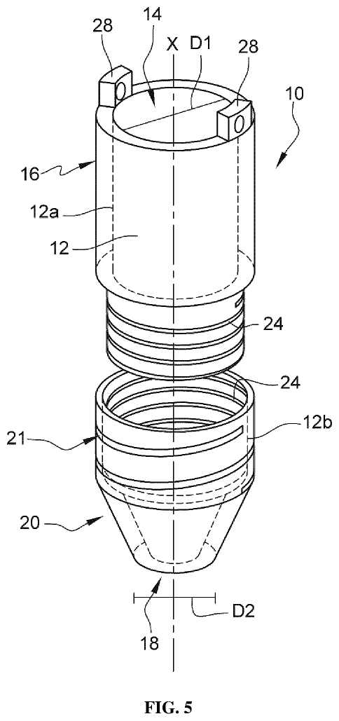

In the embodiments of FIGS. 4, 5 and 6, the first extremity 16 of the reaction unit 10 comprises mechanical clinging means 28 configured to connect the reaction unit to a carrying device, like for example a Hamilton® robot. In the embodiment of FIG. 4, said mechanical clinging means 28 comprise a ferruginous ring surrounding the first opening 14 able to cooperate with a magnetic element of a carrying device. In the embodiments of FIGS. 5 and 6, the mechanical clinging means 28 comprise two abutment elements able to cooperate with a gripper pr a clip. Both systems enable to perform and store different synthesis reactions, each comprising 1 to more than 5000 cycles, without human intervention.

The advantage of this the reaction unit 10 according to the present invention, is to be able to easily change the filtration features by changing the reaction unit. It thus offers many possibilities of filter choices. In addition, each reaction unit 10 being individual, on the same plate several filtration conditions can be carried out and the reaction conditions can be changed during the synthesis if necessary. Individualization also has the advantage of eliminating the risk of cross contamination or the loss of all samples if one reaction unit 10 appeared to be defective.

Another advantage of the reaction unit according to the present invention is it inertia, it's passivity and its universality: the reaction unit 10 according to the present invention is a passive, inert and universal unit which can easily and spontaneously be adapted to any protocol without any specific modification, once the filter element has been determined. There is no need to encapsulate specific reactants before adding the reaction solution. It can therefore be used for any kind of reactions in any kind of conditions with any kind of reaction solutions. It only takes to pour the reaction solution inside the reaction unit 10 and to apply the desired reaction protocol. Once rinsed, it could theoretically be reused, if some hygiene and safety measures were not to be applied in medical environments. The reaction unit 10 per se is not affected by the reaction(s) which take place inside its hollow body 12.

The reaction unit 10 according to the present invention is thus integrable into a more complex reaction system (not shown).

1. A reaction unit configured to receive a reaction solution and configured to be placed inside a thermocycler, said reaction unit comprising an elongated hollow body extending along a flowing axis X, the elongated hollow body defining a first opening at its first extremity and a second opening at its second extremity,
wherein walls of the elongated hollow body are at least partially made of a thermally conductive material, and
wherein the reaction unit further comprises at least one filter element extending inside the elongated hollow body, the filter element being secured in a sealed way to the walls of the elongated hollow body over its complete circumference, leading any fluid flowing from the first opening to the second opening to cross the at least one filter element.

2. The reaction unit according to claim 1, wherein a diameter of the first opening is larger than a diameter of the second opening.

3. The reaction unit according to claim 1, wherein the elongated hollow body has a general frustoconical shape, the at least one filter element being situated in a frustoconical second extremity of the elongated hollow body.

4. The reaction unit according to claim 1, wherein the at least one filter element is made of a hard material.

5. The reaction unit according to claim 1, wherein the at least one filter element comprises a filter membrane made of a flexible material.

6. The reaction unit according to claim 1, wherein the elongated hollow body comprises a first part and a second part configured to be removably assembled with each other, the first part comprising the first opening, the second part comprising the second opening and further comprising the at least one filter element.

7. The reaction unit according to claim 6, wherein the second part is a frustoconical second extremity of the elongated hollow body.

8. The reaction unit according to claim 1, wherein the thermally conductive material comprises aluminum.

9. The reaction unit according to claim 1, wherein the reaction unit further comprises a sealing cap configured to seal the first opening.

10. The reaction unit according to claim 9, wherein the sealing cap is configured to seal the first opening in a removable way.

11. The reaction unit according to claim 1, wherein a first extremity of the reaction unit comprises mechanical clinging means configured to connect the reaction unit to a carrying device.

12. The reaction unit according to claim 1, wherein a second extremity of the reaction unit includes an external connection means configured to cooperate with the thermocycler.

13. The reaction unit according to claim 1, wherein the reaction unit comprises at least two reaction compartments connected along the flowing axis X, each of the reaction compartments comprising one of the filter elements, all the filter elements being, when all the reaction compartments are assembled, aligned along the flowing axis X.

14. The reaction unit according to claim 13, wherein each of the filter elements has different filtering properties.

15. The reaction unit according to claim 1, wherein the reaction unit is a passive element which is not affected by the reaction carried inside the elongated hollow body.
